(19) United States
(12) Patent Application Publication
(10) Pub. No.: US 2002/0143946 A1
(43) Pub. Date: Oct. 3, 2002

(54) Software based internet protocol address selection method and system

(76) Inventor: Daniel Crosson, Ft. Collins, CO (US)

Correspondence Address: HEWLETT-PACKARD COMPANY, Intellectual Property Administration, P. O. Box 272400, Fort Collins, CO, 80527-2400, US

(21) Appl. No.: 09/819,911

(22) Filed: Mar. 28, 2001

(51) Int. Cl. G06F 15/173; G06F 15/16

(52) U.S. Cl. 709/226; 709/230

(57) ABSTRACT

A method and system for software based internet protocol (IP) address selection is disclosed. The method describes steps of assigning a single domain name to a set of server IP addresses, receiving a request for the domain name from a client IP address, retrieving a set of IP routes linking the server IP addresses and the client IP address, and selecting an IP route from the set of routes which meets predetermined criteria.

The system includes a set of servers, having a single domain name, a client computer, a set of routers, coupled to the servers and the client computer, for storing IP routes between the servers and the client; and a domain name system server, coupled to the routers, for selecting one of the IP routes which meets predetermined criteria.

### BACKGROUND OF THE INVENTION

1. Field of the Invention

The present invention relates generally to methods for IP address selection, and more particularly to a software based internet protocol address selection method.

2. Discussion of Background Art

Universal Resource Locater (URL) Domain Name System (DNS) entries are uniquely associated with Internet Protocol (IP) addresses and help route communications traffic between clients and servers within the World Wide Web.

When a company's servers share a single location, IP address routers simply route all traffic to this single location. However, as more and more companies establish a multi-regional or global presence, mirrored servers hosting such companies' web sites may be geographically distributed over several locations in order to ensure sufficiently short response times to client requests. As a result, Web site managers are confronted with a problem of which server will provide the best possible response time and performance for the client.

There are several current approaches to this problem. The simplest is to require that the client select a server from a list provided on the company's main Web site. Other approaches use specialized hardware to perform various measurements in order to direct clients to the best Web server. These types of solutions however typically involve the installation of very expensive hardware and require additional layers of IT support. Such hardware can thus be cost prohibitive to some smaller companies. Cisco System's Distributed Director http://www.cisco.com/warp/public/cc/pd/cxsr/dd/tech/dd_wp.htm is an example of one such hardware based solution. Other vendors, such as ArrowPoint and Foundry are also pursuing a variety of hardware based approaches to solve this domain name resolution problem.

In response to the concerns discussed above, what is needed is a system and method for internet protocol address selection that overcomes the problems of the prior art.

### SUMMARY OF THE INVENTION

The present invention is a method and system for software based internet protocol (IP) address selection. The method includes steps of assigning a single domain name to a set of server IP addresses, receiving a request for the domain name from a client IP address, retrieving a set of IP routes linking the server IP addresses and the client IP address, and selecting an IP route from the set of routes which meets predetermined criteria.

In other aspects of the invention, the method may transmit an IP address from the set of server IP addresses which corresponds to the selected IP route or retrieve the IP routes from routers using BGP, SNMP (MNB retrieval), or Telnet protocols and store the IP routes in cache and IP routes databases. Alternate embodiments may also select a best IP route between the client and server based on a shortest AS path, a lowest origin type, a lowest MED, a default IP address or a hierarchy of some or all of these criteria. A enhanced address resource record data-structure for supporting the present invention may include domain name, list of corresponding servers and routers, router retrieval parameters, default client/server IP route, and timeout fields.

The system includes a set of servers, having a single domain name, a client computer, a set of routers, coupled to the servers and the client computer, for storing IP routes between the servers and the client; and a domain name system server, coupled to the routers, for selecting one of the IP routes which meets predetermined criteria.

The system may also include a cache database, coupled to the domain name system server, for storing previously selected IP routes and an IP routes database, coupled to the domain name system server, for storing all of the IP routes.

The system and method of the present invention are particularly advantageous over the prior art because of a lower cost and a simpler design associated with implementing IP route selection using the present invention's software instead of hardware. The present invention thus is able to meet the needs of many companies that are unable to afford hardware-based systems.

These and other aspects of the invention will be recognized by those skilled in the art upon review of the detailed description, drawings, and claims set forth below.

### BRIEF DESCRIPTION OF THE DRAWINGS

FIG. 1 is a dataflow diagram for software based internet protocol address selection within a Domain Name System (DNS) server;

FIG. 2 is a data structure of an enhanced address resource record;

FIG. 3 is a dataflow diagram of an initialization process;

FIG. 4 is a dataflow diagram of an BGP IP Routes retrieval process within the initialization process;

FIG. 5 is a dataflow diagram of an MIB IP Routes retrieval process within the initialization process;

FIG. 6 is a dataflow diagram of a Telnet IP Routes retrieval process within the initialization process;

FIG. 7 is a dataflow diagram of a best client/server IP Route selection process;

FIG. 8 is a dataflow diagram of an MIB IP Routes retrieval subroutine within the best route selection process; and

FIG. 9 is a dataflow diagram of an Telnet IP Routes retrieval subroutine within the best route selection process.

### DETAILED DESCRIPTION OF THE PREFERRED EMBODIMENT

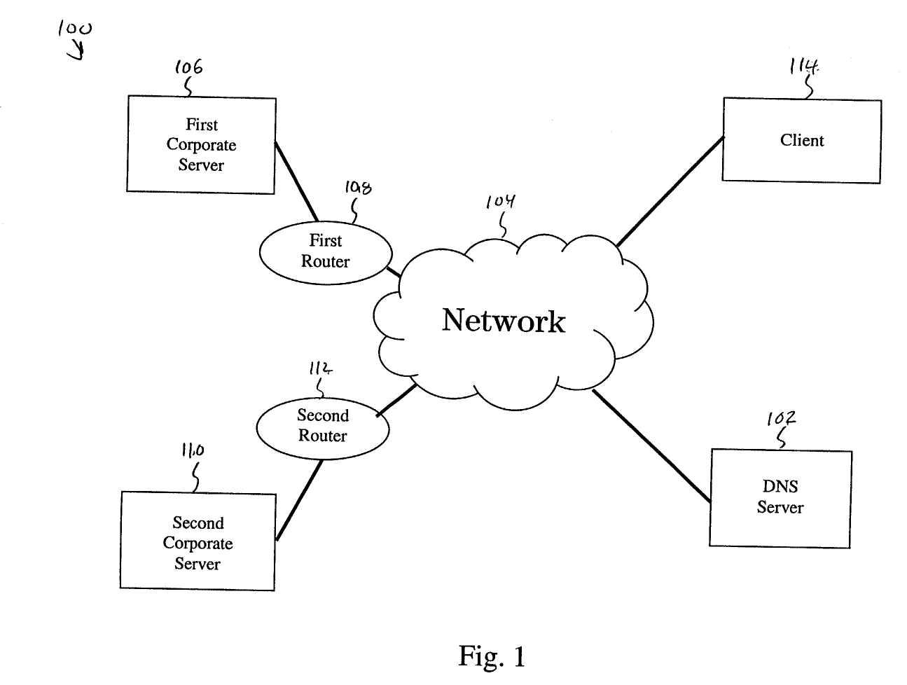

FIG. 1 is a dataflow diagram 100 for software based internet protocol address selection within a Domain Name System (DNS) server 102. The DNS server 102 is coupled to a network along with a first corporate server 106 router 108 pair, a second corporate server 110 router 112 pair, and a client computer 114. The corporate servers 106 and 110 both have a same corporate domain name (e.g. corporation@corp.com) but have different Internet Protocol (IP) addresses. The corporate servers 106 and 110 are preferably mirrored and located at different geographic locations. The DNS server 102 contains a modified bind-code for downloading IP route information from the routers 108, 112 and selecting a best client/server IP route for connecting the client 114 requesting the corporate domain name to one of the corporate servers 106, 110. An IP route is defined by at least two IP addresses. Client/server IP routes are defined between the client's 114 IP address and each of the server's 106, 110 IP addresses. Those skilled in the art recognize that in actual operable systems incorporating the present invention, hundreds, if not thousands of client computers, and tens of servers and routers may be connected to the network 104. As such, the DNS server 102 will select a best client/server IP route for connecting each client with one of the servers and transmit a server IP address corresponding to the best route to the client 114.

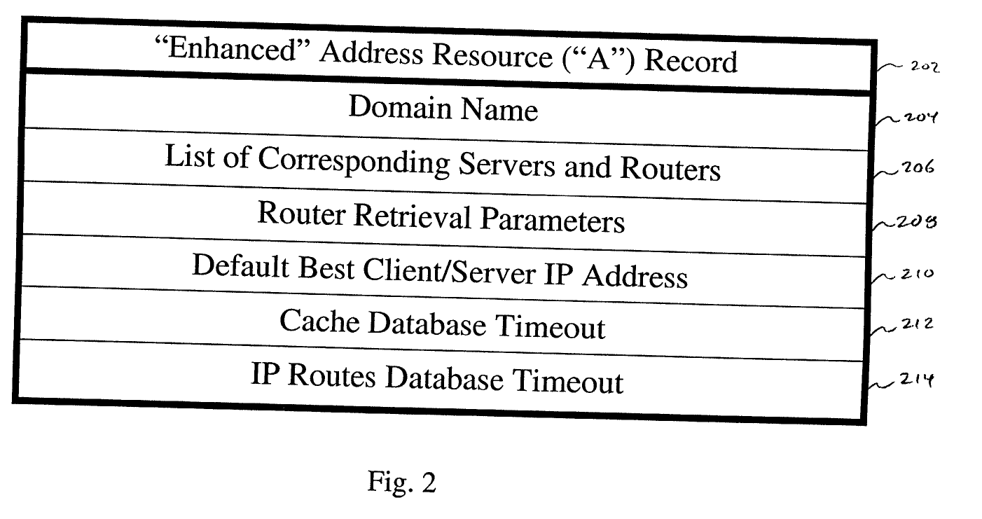

FIG. 2 is a data structure 200 of an enhanced address resource (“A”) record 202 generated by the modified bind-code of the DNS server 102. The “A” record 202 includes: a domain name 202 field for storing the corporate server's 106,110 common domain name; a list of corresponding servers and routers 204 field for identifying servers and routers assigned to the domain name 202; a route retrieval parameters 208 field specifying how IP routes are to be downloaded from the routers 108, 112, a default best client/server IP address 210 field containing an IP address for the client 114 to use should the selection process for the best client/server IP route be indeterminate; a cache timeouts field 212; and an IP routes timeouts field 214, for respectively keeping cache and IP route information fresh.

The router retrieval protocol 208 field is set to either Border Gateway Protocol (BGP), Management Information Base (MIB), or Telnet during configuration of the network 104 and the DNS server 102. One protocol 208 is used for all routers 108, 112.

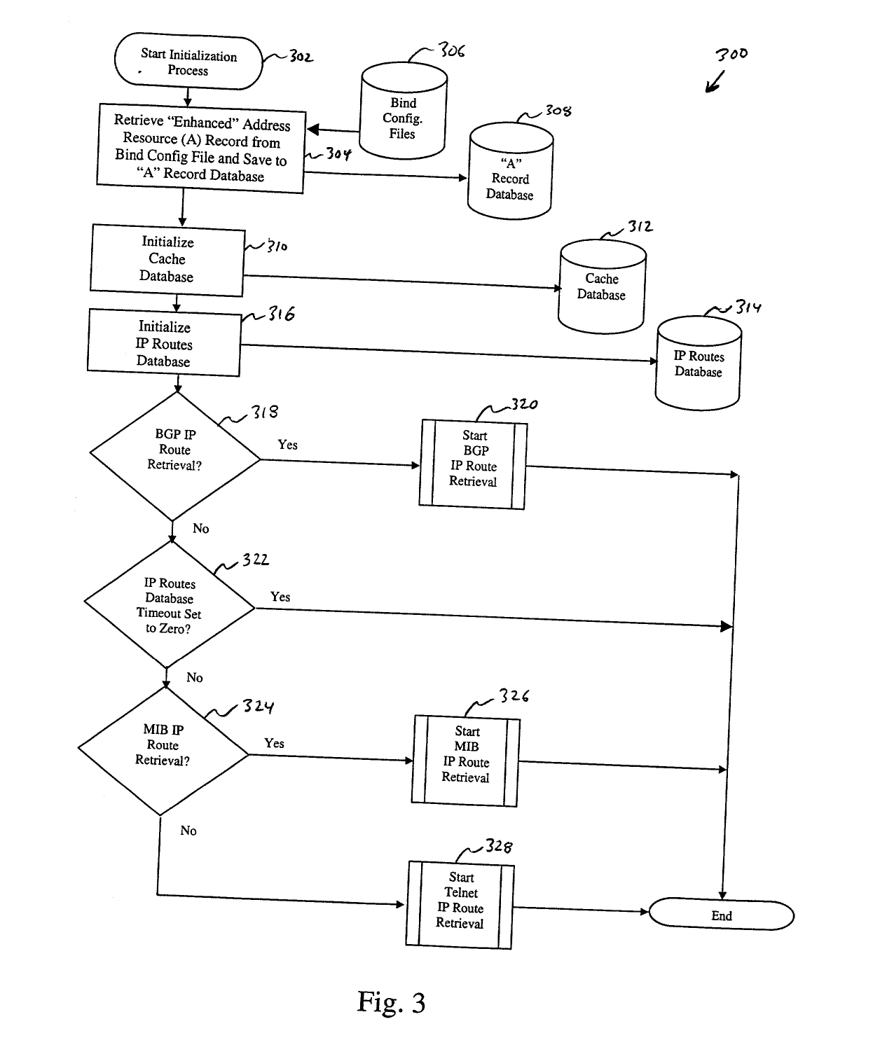

FIG. 3 is a dataflow diagram 300 of an initialization process 302. All steps are effected by software within the DNS server 102 unless otherwise noted. Initialization 302 begins in step 304 where the “A” record 202 is generated using a network bind configuration file 306 and saved in an “A” record database 308. In step 310, a cache database 312, for storing a set of previously selected best client/server IP route entries, is initialized. Caching improves IP route selection speed and efficiency in response to repeated communications from a same client or from a same client network address range. An IP route database 314, containing all possible client/server IP routes, is initialized in step 316.

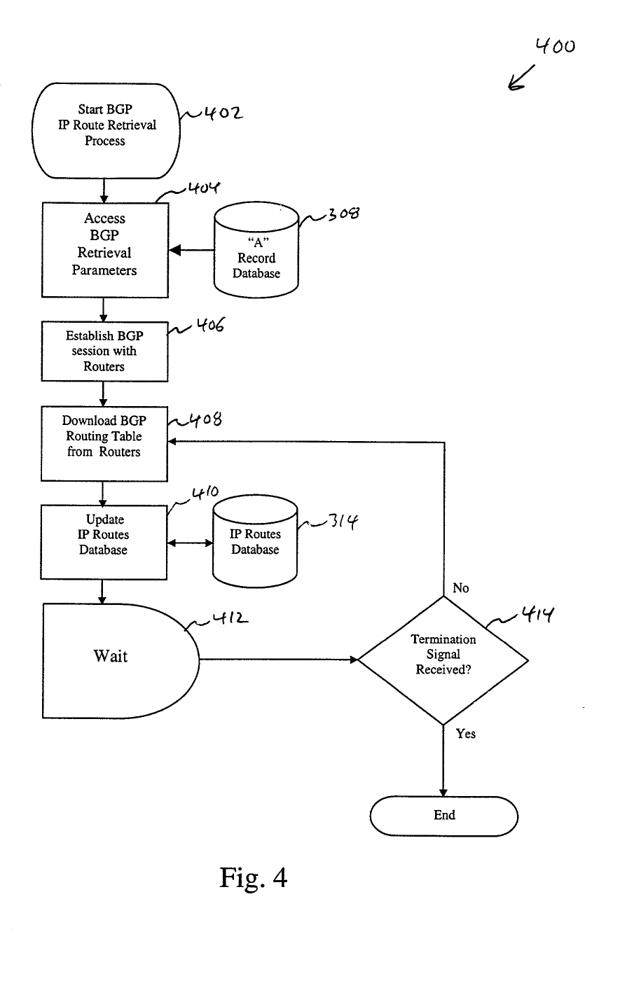

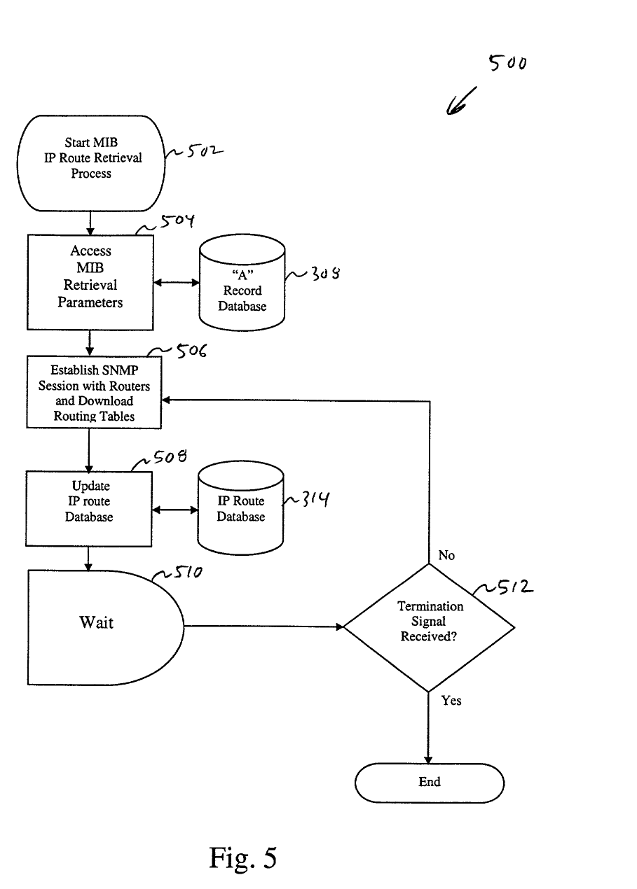

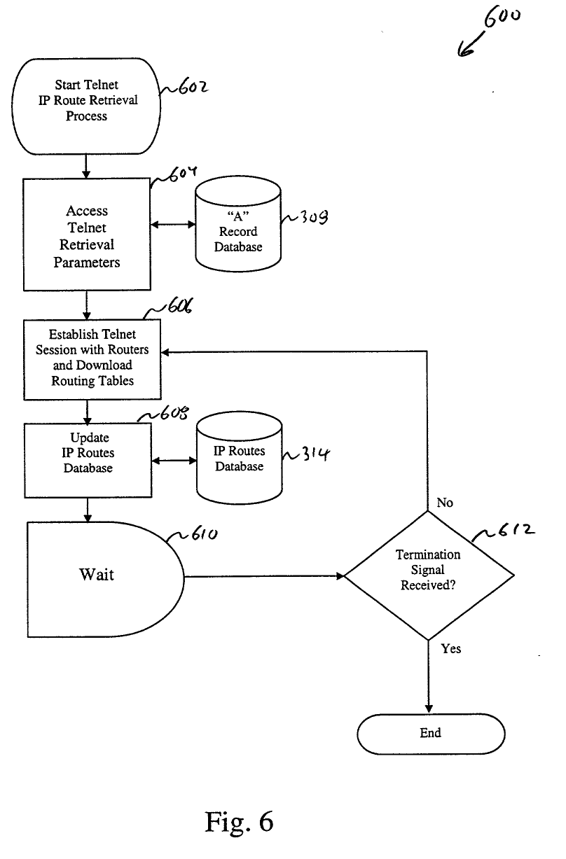

In step 318, if a protocol within the router retrieval parameters 208 is set to BGP, a BGP IP route retrieval routine is initiated in step 320, after which the initialization process 302 ends. The BGP IP route retrieval routine is described with reference to FIG. 4. In step 322, the IP routes database timeout 214 in the enhanced “A” record 202 is accessed and if the timeout is set to zero, so as to force dynamic route retrieval, the initialization process 302 ends. In step 324, if the protocol within the router retrieval parameters 208 is set to MIB, a MIB IP route retrieval routine is initiated in step 326, after which the initialization process 302 ends. The MIB IP route retrieval routine is described with reference to FIG. 5. Otherwise, the protocol within the router retrieval parameters 208 is Telnet, and a Telnet IP route retrieval routine is initiated in step 328, after which the initialization process 302 ends. The Telnet IP route retrieval routine is described with reference to FIG. 6.

FIG. 4 is a dataflow diagram 400 of the BGP IP Route retrieval process 402 within the initialization process 302. The process 402 begins in step 404, where BGP specific information is accessed from the router retrieval parameters 208 in the enhanced “A” records 202 stored in the “A” record database 308. In step 406, a BGP session is established with the routers 108, 112. BGP code is incorporated into the DNS server's 102 software so that the DNS server 102 can directly peer with the routers. Thus the IP routes database 314 can be updated real time. Next, in step 408, a BGP routing table is downloaded from the routers 108, 112. The IP route database 314 is updated, in step 410. In step 412, the process 402 waits for a BGP protocol update signal or a termination signal. If, in step 414, the termination signal is not received, the process 402 returns to step 408, else the process 402 ends. As discussed with reference to FIG. 1, those skilled in the art will know that the present invention works equally well with many more than just the one client and two servers and routers discussed herein.

FIG. 5 is a dataflow diagram 500 of the MIB IP Routes retrieval process 502 within the initialization process 302. The process 502 begins in step 504, where MIB specific information is accessed from the router retrieval parameters 208 in the enhanced “A” records 202 stored in the “A” record database 308. In step 506, a Simple Network Management Protocol (SNMP) session is established with and routing tables are downloaded from the routers 108, 112. The process 502 uses network management protocols to retrieve IP routes from a router's management information base. The IP route database 314 is updated, in step 508. In step 510, the process 502 waits for the IP route database timeout to zero or a termination signal. If, in step 512, the termination signal is not received, the process 502 returns to step 506, else the process 502 ends.

FIG. 6 is a dataflow diagram 600 of the Telnet IP Routes retrieval process 602 within the initialization process 302. The process 602 begins in step 604, where Telnet specific information is accessed from the router retrieval parameters 208 in the enhanced “A” records 202 stored in the “A” record database 308. In step 606, a Telnet session is established with and routing tables are downloaded from the routers 108, 112. The routing table information is updated periodically to keep the IP routes database 314 current. The IP route database 314 is updated, in step 608. In step 610, the process 602 waits for the IP route database timeout to zero or a termination signal. If, in step 612, the termination signal is not received, the process 602 returns to step 606, else the process 602 ends.

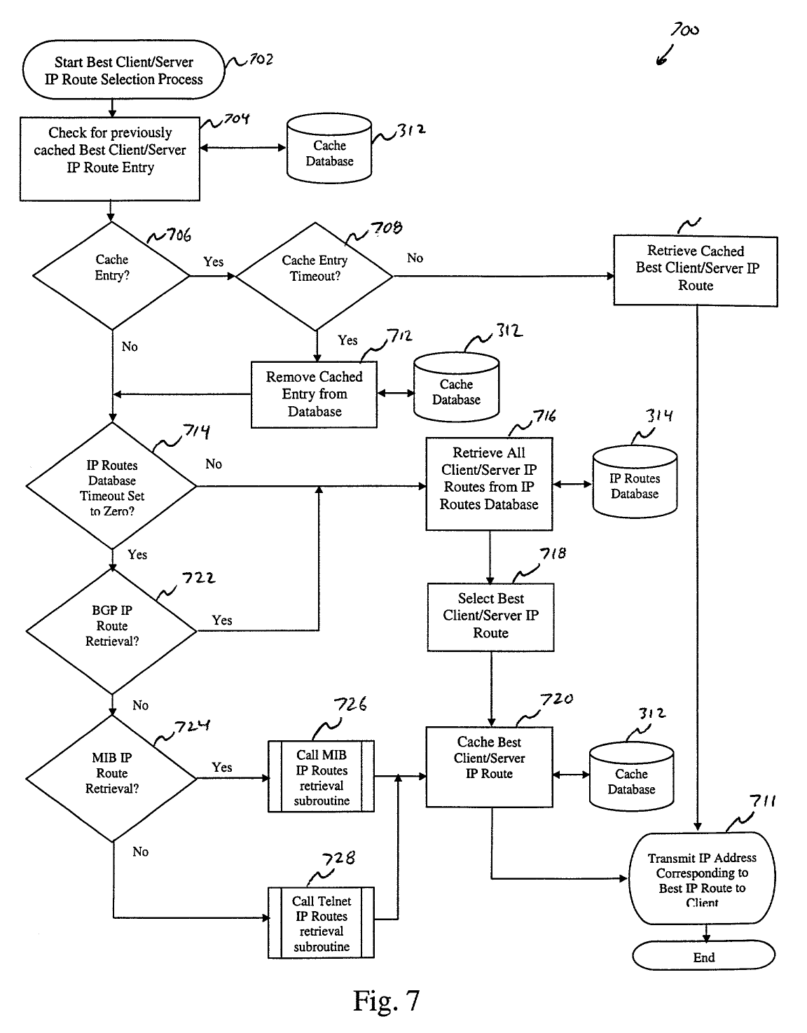

FIG. 7 is a dataflow diagram 700 of a best client/server IP Route selection process 702. The process 702 begins in step 704 where in response to a domain name request from the client 114, the DNS server 102 checks the cache database 312 for a previously cached best client/server IP route entry between the client 114 and one of the domain name servers 106, 110. In step 706, if the best client/server IP route cache entry exists, the cache timeouts 212 are accessed. In step 708, if the cache entry has not timed out, the process 702 proceeds to step 710. In step 710, the best client/server IP route cache entry is retrieved from the cache database 312 and a server IP address corresponding to the best route is transmitted to the client 114 in step 711. After step 711, the process 702 ends. In step 708, if the best client/server IP route cache entry has timed out, the process proceeds to step 714. In step 712, the cache entry is removed from the cache database 312.

Next, in step 714, the IP routes database timeout 214 is accessed. If the IP routes database 314 has a non-zero timeout value, the process proceeds to step 716 where the DNS server 102 retrieves all Client/Server IP Routes from the IP routes database 314. In step 716, the DNS server 102 selects a best client/server IP route for the client 114 from all of the client/server IP routes stored in the IP routes database 314.

The DNS server 102 sets the best client/server IP route equal to the IP route having a shortest Autonomous System (AS) path. The AS path is a BGP protocol attribute containing a sequence of autonomous system numbers which a route has traversed to reach a destination. If the AS path for all client/server IP routes is equivalent, the DNS server 102 instead selects the client/server IP route with a lowest origin type. Origin type is a BGP protocol attribute indicating an origin of a routing update with respect to an autonomous system that originated it. If the origin type for all client/server IP routes is equivalent, the DNS server 102 instead selects the client/server IP route with a lowest Multi_Exit_Disc (MED). MED is a BGP protocol attribute that describes an external metric of a route. If the MED for all client/server IP routes is equivalent, the DNS server 102 instead selects the default best client/server IP address 210 which is retrieved from the enhanced “A” record 202. Those skilled in the art recognize that other best IP route selection methods are possible. In step 720, the DNS server 102 caches the best client/server IP route in the cache database 312 and the process 702 proceeds to step 711, which has been discussed above.

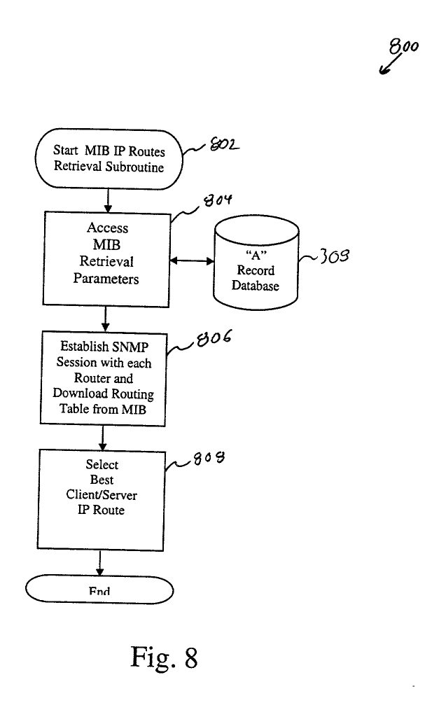

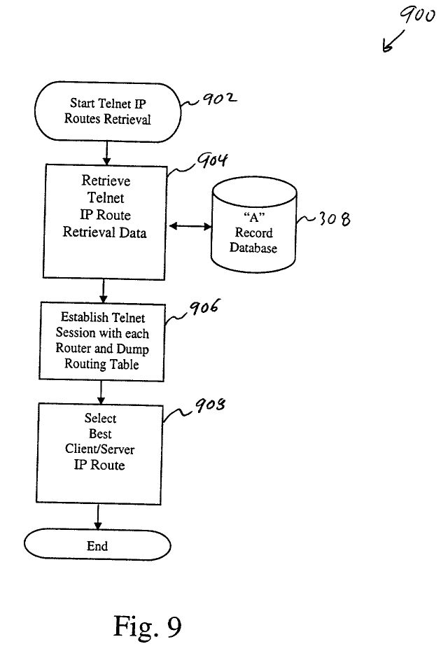

In step 714, if the IP routes database 314 has a zero timeout value, the process proceeds to step 722. In step 722, the DNS server 102 accesses the protocol specified within the router retrieval parameters 208. If the protocol is set to BGP, then the IIP routes database 314 will be updated continuously, and the process proceeds to step 716. Step 716 is discussed above. Else, the process proceeds to step 724. In step 724, the DNS server 102 accesses the protocol specified within the router retrieval parameters 208. If the protocol is set to MIB, the process proceeds to step 726. In step 726, a MIB IP routes retrieval subroutine is executed, as described with reference to FIG. 8. After step 726, the process proceeds to step 720 discussed above. If the protocol was not set to MIB, the protocol defaults to Telnet and the process 702 proceeds to step 728. In step 728, a Telnet IP routes retrieval subroutine is executed, as described with reference to FIG. 9. After step 728, the process proceeds to step 720 discussed above.

FIG. 8 is a dataflow diagram 800 of an MIB IP Routes retrieval subroutine 802 within the best route selection process 702. The process 802 begins in step 804, where SNMP (MIB retrieval) information is accessed from the router retrieval parameters 208. In step 806, an SNMP session is established with the routers 108, 112, and routing tables are downloaded real-time from a MIB database on the routers. A best client/server IP route is selected from all client/server IP routes downloaded within the routing tables in step 808. The best IP route is selected using the steps discussed with reference to step 718 in FIG. 7, except that the IP routes in the IP routes database 314 are not accessed. After step 808, the process 802 ends.

FIG. 9 is a dataflow diagram 900 of an Telnet IP Routes retrieval subroutine 902 within the best route selection process. The process 902 begins in step 904, where Telnet information is accessed from the router retrieval parameters 208. In step 906, a Telnet session is established with the routers 108, 112 and routing tables are downloaded real-time using the Telnet protocol. A best client/server IP route is selected from all client/server IP routes downloaded within the routing tables in step 908. The best IP route is selected using the steps discussed with reference to step 718 in FIG. 7, except that the IP routes in the IP routes database 314 are not accessed. After step 908, the process 902 ends.

While one or more embodiments of the present invention have been described, those skilled in the art will recognize that various modifications may be made. Variations upon and modifications to these embodiments are provided by the present invention, which is limited only by the following claims.

What is claimed is:

1. A method for internet protocol (IP) address selection, comprising the steps of:
assigning a single domain name to a set of server IP addresses;
receiving a request for the domain name from a client IP address;
retrieving a set of IP routes linking the server IP addresses and the client IP address; and
selecting an IP route from the set of routes which meets predetermined criteria.

2. The method of claim 1 wherein the retrieving step includes the step of:
retrieving the set of IP routes from a cache database.

3. The method of claim 1 wherein the retrieving step includes the step of:
retrieving the set of IP routes from an IP routes database.

4. The method of claim 1 wherein the retrieving step includes the step of:
retrieving the set of IP routes from a set of routers using a BGP protocol.

5. The method of claim 1 wherein the retrieving step includes the step of:
retrieving the set of IP routes from a set of routers using an SNMP (MIB retrieval) protocol.

6. The method of claim 1 wherein the retrieving step includes the step of:
retrieving the set of IP routes from a set of routers using a Telnet protocol.

7. The method of claim 1 wherein the selecting step includes the step of:
selecting the IP route from the set which has a shortest AS path.

8. The method of claim 1 wherein the selecting step includes the step of:
selecting the IP route from the set which has a lowest origin type.

9. The method of claim 1 wherein the selecting step includes the step of:
selecting the IP route from the set which has a lowest MED.

10. The method of claim 1 wherein the selecting step includes the step of:
selecting the IP route from the set equal to a default IP address.

11. The method of claim 1 further comprising the step of:
storing the IP routes in a cache database.

12. The method of claim 1 further comprising the step of:
storing the IP routes in an IP routes database.

13. The method of claim 1 further comprising the step of:
defining an enhanced address resource record, including a domain name, a list of corresponding servers and routers, router retrieval parameters, a default client/server IP route, and timeouts.

14. The method of claim 1 further comprising the step of:
transmitting an IP address from the set of server IP addresses which corresponds to the selected IP route.

15. A computer-usable medium embodying computer program code for commanding a computer to perform internet protocol address selection, comprising the steps of:
assigning a single domain name to a set of server IP addresses;
receiving a request for the domain name from a client IP address;
retrieving a set of IP routes linking the server IP addresses and the client IP address; and
selecting an IP route from the set of routes which meets predetermined criteria.

16. The computer-usable medium of claim 15 wherein the retrieving step includes the step of:
retrieving the set of IP routes from a cache database.

17. The computer-usable medium of claim 15 wherein the retrieving step includes the step of:
retrieving the set of IP routes from a set of routers using a BGP protocol.

18. The computer-usable medium of claim 15 wherein the retrieving step includes the step of:
retrieving the set of IP routes from a set of routers using an SNMP (MIB retrieval) protocol.

19. The computer-usable medium of claim 15 wherein the retrieving step includes the step of:
retrieving the set of IP routes from a set of routers using a Telnet protocol.

20. The computer-usable medium of claim 15 wherein the selecting step includes the step of:
selecting the IP route from the set which has a shortest AS path.

21. The computer-usable medium of claim 15 wherein the selecting step includes the step of:
selecting the IP route from the set which has a lowest origin type.

22. The computer-usable medium of claim 15 wherein the selecting step includes the step of:
selecting the IP route from the set which has a lowest MED.

23. The computer-usable medium of claim 15 wherein the selecting step includes the step of:
selecting the IP route from the set equal to a default IP address.

24. The computer-usable medium of claim 15 further comprising the step of:
transmitting an IP address from the set of server IP addresses which corresponds to the selected IP route.

25. A system for internet protocol (IP) address selection comprising a:
a set of servers, having a single domain name;
a client computer;
a set of routers, coupled to the servers and the client computer, for storing IP routes between the servers and the client; and
a domain name system server, coupled to the routers, for selecting one of the IP routes which meets predetermined criteria.

26. The system of claim 25 further comprising:
a cache database, coupled to the domain name system server, for storing previously selected IP routes.

27. The system of claim 25 further comprising:
an IP routes database, coupled to the domain name system server, for storing all of the IP routes.

28. The system of claim 25 where:
the domain name system server includes an enhanced address resource record storing the single domain name, a list of the servers and routers, a set of router retrieval parameters, a default IP route, and timeouts; and
the domain name system server accesses the retrieval parameters in order to select the IP routes.
